(19) United States
(12) Patent Application Publication
(10) Pub. No.: US 2002/0089627 A1
(43) Pub. Date: Jul. 11, 2002

(54) Projection type liquid crystal display apparatus having optimum optical shield plate, method and apparatus for assembling the same

(75) Inventor: Kouichi Kayanuma, Tokyo (JP)

Correspondence Address: SUGHRUE, MION, ZINN, MACPEAK & SEAS, 2100 Pennsylvania Avenuem N.W., Washington, DC, 20037, US

(73) Assignee: NEC VIEWTECHNOLOGY, LTD.

(21) Appl. No.: 10/032,537

(22) Filed: Jan. 2, 2002

(30) Foreign Application Priority Data
Jan. 5, 2001 (JP) 2001-000526

(51) Int. Cl. G02F 1/1333

(52) U.S. Cl. 349/110

(57) ABSTRACT

In a projection type liquid crystal display apparatus including a liquid crystal panel body including a display region and anon-display region surrounding the display region, at least one optical shield plate is provided for covering the non-display region. An edge of the optical shield plate is completely in conformity with a boundary of the display region and the non-display region.

### BACKGROUND OF THE INVENTION

1. Field of the Invention

The present invention relates to a projection type liquid crystal display (LCD) apparatus for use in a projector.

2. Description of the Related Art

Generally, a projection type LCD apparatus is constructed by a liquid crystal panel body including a display region and a non-display region surrounding the display region. In a projector, when light is irradiated onto the liquid crystal panel body, a part of the light penetrates the non-display region which would generate a halation on a screen.

In order to prevent light from being incident to the non-display region, a first prior art projection-type LCD apparatus includes an optical shield plate for covering the non-display region (see: Japanese Utility Model Publication No. 3-75418).

In the above-described first prior art projection type LCD apparatus, however, since the optical shield plate is L-shaped to be in conformity with the edge of the liquid crystal panel body, it is impossible to accurately adjust the location of the optical shield plate with respect to the liquid crystal panel body, so that it is not always possible to avoid the generation of halations on the screen. Additionally, since the optical shield plate is provided opposite to a light source, it is impossible to prevent light from being incident to the non-display region.

A second prior art projection type LCD apparatus includes a frame type optical shield plate for covering the non-display region via a dust-proof member (see: JP-A-11-305674).

Even in the above-described second prior art projection type LCD apparatus, since the optical shield plate is of a frame type, it is impossible to accurately adjust the location of the optical shield plate with respect to the liquid crystal panel body, so that it is not always to avoid the generation of halations on the screen. Additionally, since the dust-proof member exists between the optical shield plate and the liquid crystal panel body, it is impossible to determine whether or not the location of the optical shield plate is optimum before the assembling of the optical shield plate and the dust-proof member is completed. If a reassembling operation is required, this increases the manufacturing cost.

### SUMMARY OF THE INVENTION

It is an object of the present invention to provide a projection type LCD apparatus for use in a projector with an optimum optical shield plate.

Another object is provide a method and apparatus for assembling the above-mentioned projection type LCD apparatus.

According to the present invention, in a projection type LCD apparatus including a liquid crystal panel body including a display region and a non-display region surrounding said display region, at least one optical shield plate is provided for covering the non-display region. An edge of the optical shield plate is completely in conformity with a boundary of the display region and the non-display region.

Also, in a method for assembling a projection type LCD apparatus, a liquid crystal panel body including a display region and a non-display region surrounding the display region is irradiated with light. Then, light passed through the liquid crystal panel body is received while an optical shield plate in proximity to the liquid crystal panel body is moved along one direction. Finally, motion of the optical shield plate is stopped when a change of strength of the received light is larger than a definite, value thus fixing the optical shield plate with respect to the liquid crystal panel body.

Further, in an apparatus for assembling a projection type LCD apparatus, a mounting unit is provided on a light source, for mounting a liquid crystal panel body including a display region and a non-display region surrounding the display region. An optical shield plate location adjusting unit is provided for adjusting a location of an optical shield plate with respect to the mounting unit. An optical shield plate location controlling unit is provided for receiving light passed through the liquid crystal panel body from the light source to control the optical shield plate location adjusting unit in accordance with light received by the optical shield plate location controlling unit.

### BRIEF DESCRIPTION OF THE DRAWINGS

The present invention will be more clearly understood from the description set forth below, with reference to the accompanying drawings, wherein:

FIG. 1A is a front view illustrating a first embodiment of the projection type LCD apparatus according to the present invention;

FIG. 1B is a side cross-sectional view of the apparatus of FIG. 1A;

FIG. 1C is a back view of the apparatus of FIG. 1A;

FIG. 2A is a front view illustrating a modification of the projection type LCD apparatus of FIG. 1A;

FIG. 2B is a side cross-sectional view of the apparatus of FIG. 2A;

FIG. 2C is a back view of the apparatus of FIG. 2A;

FIG. 3A is a front view illustrating a second embodiment of the projection type LCD apparatus of FIG. 1A;

FIG. 3B is a side cross-sectional view of the apparatus of FIG. 3A;

FIG. 3C is a back view of the apparatus of FIG. 3A;

FIG. 4A is a front view illustrating a modification of the projection type LCD apparatus of FIG. 3A;

FIG. 4B is a side cross-sectional view of the apparatus of FIG. 4A;

FIG. 4C is a back view of the apparatus of FIG. 4A;

FIG. 5A is a front view illustrating a third embodiment of the projection type LCD apparatus according to the present invention;

FIG. 5B is a side cross-sectional view of the apparatus of FIG. 5A;

FIG. 5C is a back view of the apparatus of FIG. 5A;

FIG. 6 is a diagram illustrating a first apparatus for assembling the LCD apparatus of FIGS. 1A, 1B, 1C; 2A, 2B, 2C; 3A, 3B, 3C; 4A, 4B, 4C; and 5A, 5B, 5C;

FIG. 7 is a flowchart for explaining the operation of the apparatus of FIG. 6;

FIGS. 8A and 8B are diagrams showing the light strength I and the difference ΔI of FIG. 7; and

FIG. 9 is a diagram illustrates a second apparatus for assembling the LCD apparatus of FIGS. 1A, 1B, 1C; 2A, 2B, 2C; 3A, 3B, 3C; 4A, 4B, 4C; and 5A, 5B, 5C.

### DESCRIPTION OF THE PREFERRED EMBODIMENTS

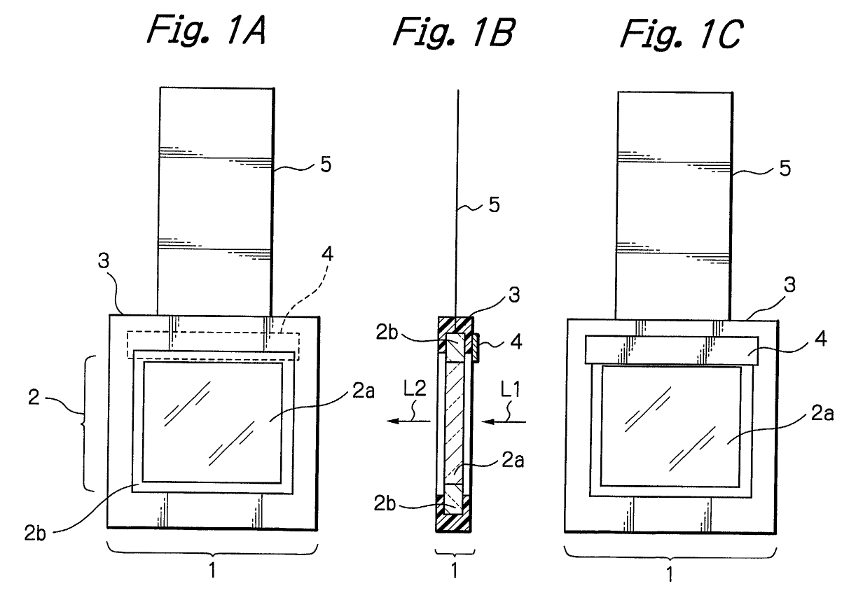

FIG. 1A is a front view illustrating a first embodiment of the projection type LCD apparatus according to the present invention, FIG. 1B is a side cross-sectional view of the apparatus of FIG. 1A, and FIG. 1C is a back view of the apparatus of FIG. 1A.

In FIGS. 1A, 1B and 1C, reference numeral 1 designates a liquid crystal panel which is constructed by a liquid crystal panel body 2, a plastic frame 3 for mounting the liquid crystal panel body 2 and an I-shaped optical shield plate 4 adhered by adhesives (not shown) to the plastic frame 3.

The liquid crystal panel body 2 is formed by transparent substrates into which liquid crystal is introduced. Also, the liquid crystal panel body 2 is divided into a display region 2a where data bus lines, gate bus lines, and pixels (thin film transistors and liquid crystal cells) each connected to one of the data bus lines and one of the gate buses and the like are formed, and a non-display region 2b surrounding the display region 2a where peripheral circuits for driving the data bus lines and the gate bus line are formed. The peripheral circuits are connected to a flexible cable 5. Also, reference L1 designates an incident light, and L2 designates a transmission light.

Generally, note that an opening of the plastic frame 3 is much larger than the display region 2a of the liquid crystal panel body 2. Therefore, if the dimension of the liquid crystal panel body 2 and/or the plastic frame 3 deviates slightly, the display region 2a of the liquid crystal panel body 2 is completely exposed to the incident light L1. On the other hand, a part of the non-display region 2b of the liquid crystal panel body 2 is also exposed to the incident light L1, so that the incident light L1 incident to the non-display region 2b is scattered within the non-display region 2b and leaked therefrom, which would generate a halation on a screen (not shown).

In order to prevent the incident light L1 from being incident to the non-display region 2b of the liquid crystal panel body 2, the optical shield plate 4 is adhered to the back side of the plastic frame 3, so that the inner edge of the optical shield plate 4 is completely in conformity with the boundary between the display region 2a and the non-display region 2b of the liquid crystal panel body 2.

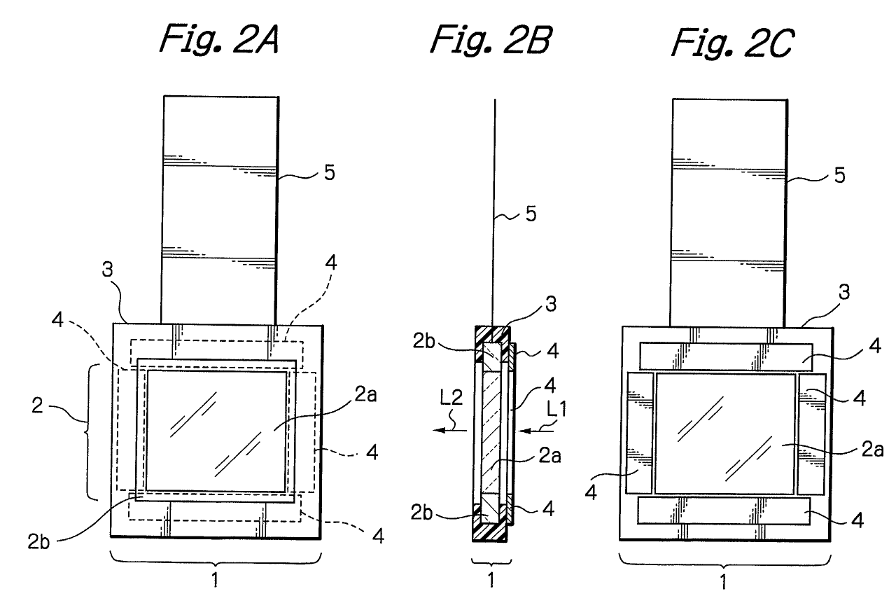

In FIGS. 1A, 1B and 1C, the optical shield plate 4 is provided on an upper side of the liquid crystal panel body 2; however, the optical shield plate 4 can be on a lower side, a right side or a left side of the liquid crystal panel body 2 depending upon where a halation is generated on the screen. Also, two, three or four optical shield plates 4 can be provided. In FIGS. 2A, 2B and 2C, which are modifications of FIGS. 1A, 1B and 1C, respectively, four optical shield plates 4 are provided on the four sides of the liquid crystal panel body 2.

Thus, in FIGS. 1A, 1B and 1C, the generation of halation on the screen can be suppressed. In addition, since the optical shield plate 4 is in direct contact with the back side of the plastic frame 3, the parallax error of the optical shield plate 4 to the plastic frame 3 can be decreased.

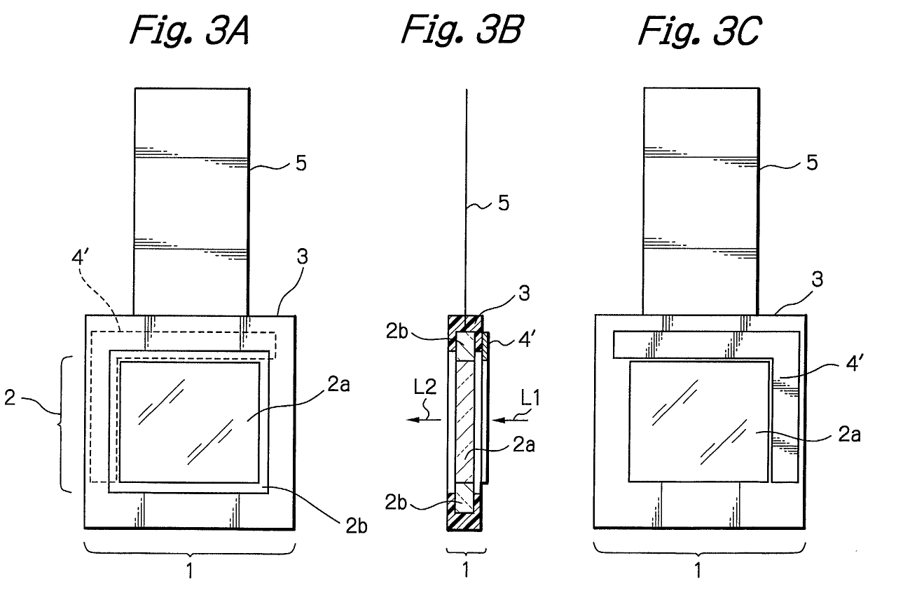

FIG. 3A is a front view illustrating a second embodiment of the projection type LCD apparatus according to the present invention, FIG. 3B is a side cross-sectional view of the apparatus of FIG. 3A, and FIG. 3C is a back view of the apparatus of FIG. 3A.

In FIGS. 3A, 3B and 3C, an L-shaped optical shield plate 4′ is provided instead of the I-shaped optical shield plate 4 of FIGS. 1A, 1B and 1C.

Even in FIGS. 3A, 3B and 3C, in order to prevent the incident light L1 from being incident to the non-display region 2b of the liquid crystal panel body 2, the optical shield plate 4′ is adhered to the back side of the plastic frame 3, so that the upper inner edge and side inner edge of the optical shield plate 4′ are completely in conformity with the boundary between the display region 2a and the non-display region 2b of the liquid crystal panel body 2.

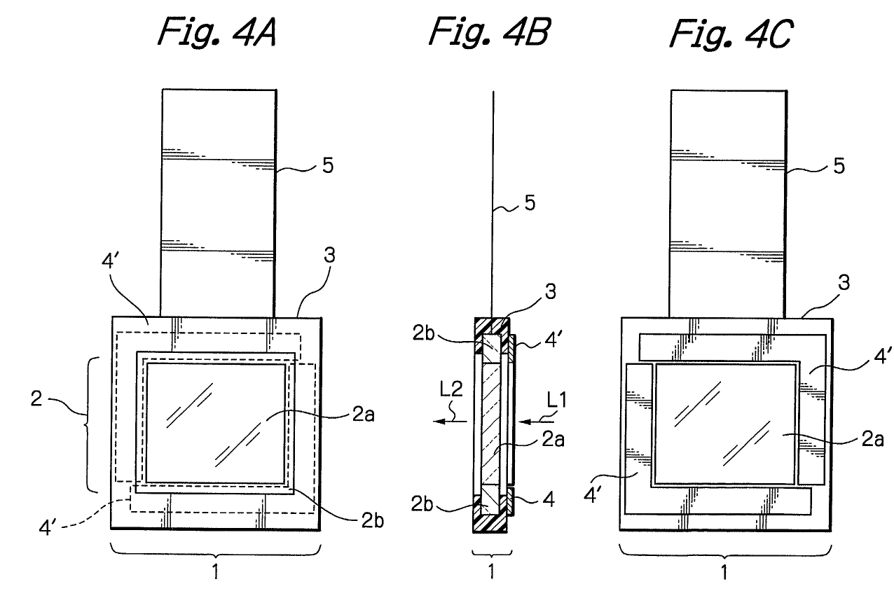

In FIGS. 3A, 3B and 3C, the optical shield plate 4′ is provided on an upper side of the liquid crystal panel body 2; however, the optical shield plate 4′ can be on a lower side of the liquid crystal panel body 2 depending upon where a halation is generated on the screen. Also, two optical shield plates 4′ can be provided. In FIGS. 4A, 4B and 4C, which are modifications of FIGS. 3A, 3B and 3C, respectively, two L-shaped optical shield plates 4′ are provided on the lower side of the liquid crystal panel body 2.

Thus, even in FIGS. 3A, 3B and 3C, the generation of halations on the screen can be suppressed. In addition, since the optical shield plate 4′ is in direct contact with the back side of the plastic frame 3, the parallax error of the optical shield plate 4′ to the plastic frame 3 can be decreased.

Further, in the second embodiment as illustrated in FIGS. 3A, 3B, 3C, 4A, 4B and 4C, since the number of optical shield plates is decreased as compared with the first embodiment as illustrated in FIGS. 1A, 1B, 1C, 2A, 2B and 2C, the manufacturing cost can be decreased.

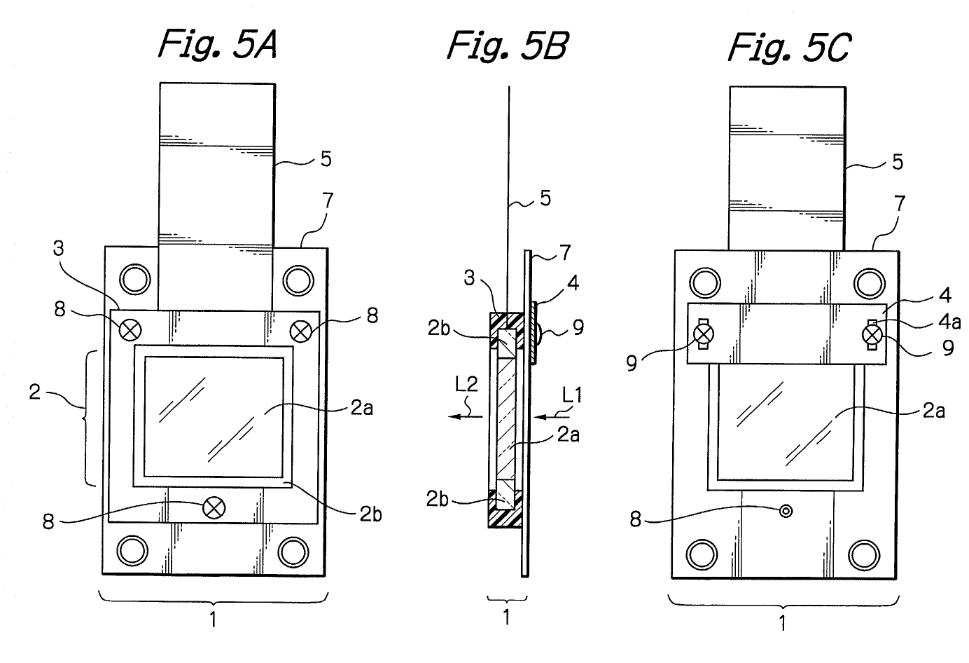

In the above-described embodiments, the adhesion of the optical shield plates 4 and 4′ to the plastic frame 3 is carried out by adhesives. However, this adhesion can be mechanically carried out as illustrated in FIGS. 5A, 5B and 5C, which illustrate a third embodiment of the LCD apparatus according to the present invention.

In FIGS. 5A, 5B and 5C, which are also modifications of FIGS. 1A, 1B and 1C, respectively, the plastic frame 3 is fixed to a metal plate 7 by screws 8. In this case, the metal plate 7 also has an opening corresponding to the liquid crystal panel body 2. Also, the optical shield plate 4 has two rectangular holes 4a within which adjusting screws 9 can move.

In FIGS. 5A, 5B and 5C, in order to prevent the incident light L1 from being incident to the non-display region 2b of the liquid crystal panel body 2, the optical shield plate 4 is moved up and down while the adjusting screws 9 are loosened, so that the inner edge of the optical shield plate 4 is completely in conformity with the boundary between the display region 2a and the non-display region 2b of the liquid crystal panel body 2. Then, the optical shield plate 4 is fixed to the metal plate 7 by tightening the adjusting screws 9.

In FIGS. 5A, 5B and 5C, the freedom of design of the LCD apparatus is increased. That is, after the assembling of the apparatus of FIGS. 5A, 5B and 5C is completed, if the readjustment of the location of the optical shield plate 4 with respect to the metal plate is required, the adjusting screws 9 are loosened and tightened to readjust the location of the optical shield plate 4. Also, after the assembling of the LCD apparatus of FIGS. 5A, 5B and 5C is completed, if the liquid crystal panel body 2 is determined to be defective, this defective liquid crystal panel body 2 is easily replaced by another liquid crystal panel body 2 by loosening and tightening the screws 8 and the adjusting screws 9.

The metal plate 7, the screws 8 and the adjusting screws 9 of FIGS. 5A, 5B and 5C can be also applied to the LCD apparatuses of FIGS. 2A, 2B, 2C; 3A, 3B, 3C; and 4A, 4B, 4C. In this case, in a case of FIGS. 3A, 3B, 3C and FIGS. 4A, 4B, 4C, since the optical shield plate 4′ is L-shaped, the optical shield plate 4′ has adequate non-rectangular holes for the adjusting screws 9.

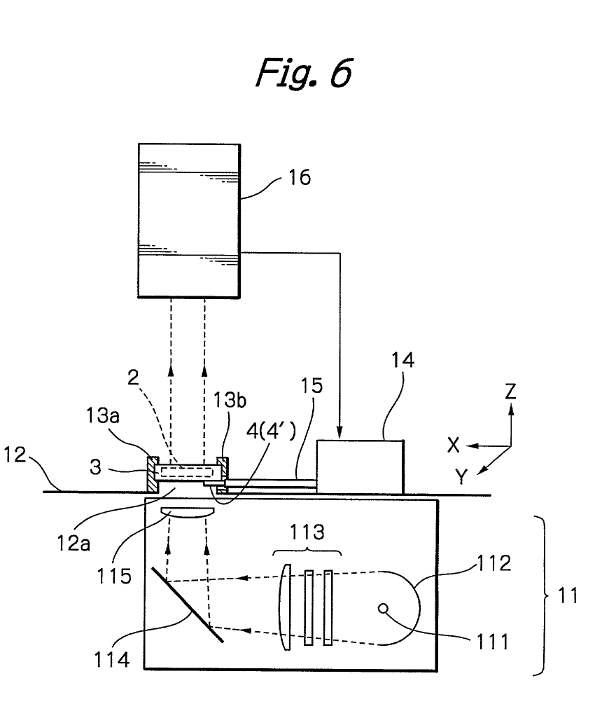

In FIG. 6, which illustrates a first apparatus for assembling the LCD apparatuses of FIGS. 1A, 1B, 1C; 2A, 2B, 2C; 3A, 3B, 3C; 4A, 4B, 4C; 5A, 5B, 5C, reference numeral 11 designates a light source for irradiating the back side of the LCD apparatus with light. The light source 11 is constructed by a xenon lamp 111, a reflector 112, a set of filters/lenses 113, a reflection mirror 114 and a condenser lens 115.

Also, a pedestal 12 is provided on the light source 11, and vises 13a and 13b for holding the plastic frame 3 along with the liquid crystal panel body 2 are provided on the pedestal 12. In this case, the pedestal 12 has an opening 12a for passing light from the light source 11 to the liquid crystal panel body 2.

Further, an optical shield plate location adjusting unit 14 is provided to adjust the location of the optical shield plate 4(4′). The optical shield plate location adjusting unit 14 has an actuator 15 for pressing the optical shield plate 4 (4′) toward the back side of the LCD apparatus, i.e., the plastic frame 3 thereof, and a ball screw mechanism and a stepping motor (not shown) for feeding the actuator 15 along X-and Y-directions.

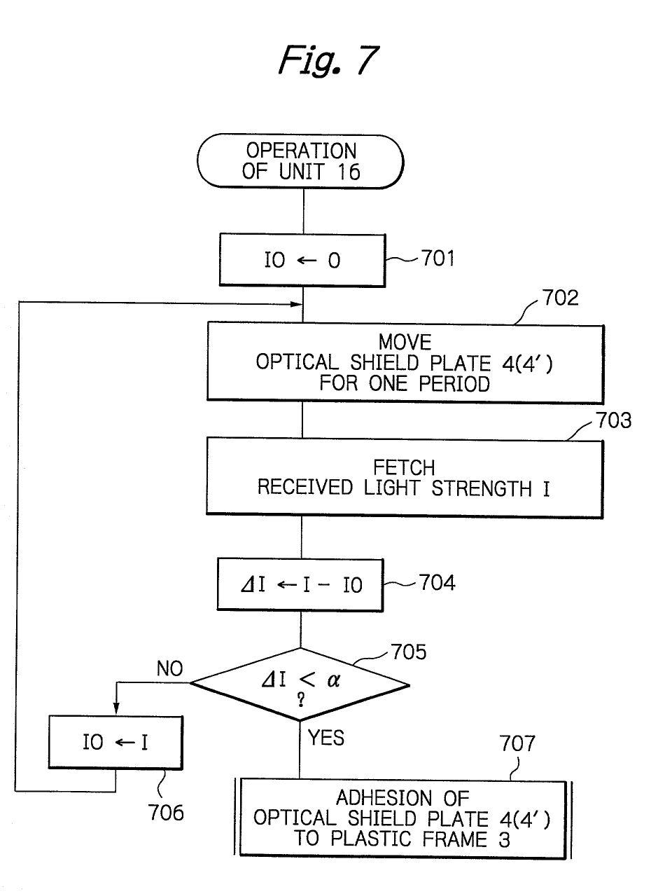

Additionally, an optical shield plate location controlling unit 16 is provided for receiving light passed through the liquid crystal panel body 2 to control the location of the optical shield plate 4(4′), so that no halation is observed. The optical shield plate location controlling unit 16 is constructed by an image pickup such as a charge coupled device (CCD) or a photometer, and a computer including a central processing unit (CPU), memories and the like. That is, the optical shield plate location controlling unit 16 controls the optical shield plate location adjusting unit 15, i.e., the location of the optical shield plate 4(4′), so that light from the light source It received by the optical shield plate location controlling unit 16 is brought close to a minimum value. In more detail, the operation of the optical shield plate location controlling unit 16 is illustrated in FIG. 7.

First, referring to step 701, a previous light strength value I0 is initialized at 0.

Next, referring to step 702, the optical shield plate 4(4′) is moved for one time period or one small distance along one direction such as the X-direction.

Next, referring to step 703, a strength I of received light is fetched.

Next, referring to step 704, the following is calculated:

ΔI←I−I0

Next, referring to step 705, it is determined whether or not ΔI<α (negative definite value). As a result, if ΔI≧α, the control proceeds to step 706 in which I0←0, thus repeating the control at steps 702, 703, 704 and 705. Otherwise, the control proceeds to step 707 which adheres the optical shield plate 4(4′) by adhesives or screws to the plastic frame 3. Thus, the operation of the optical shield plate location controlling unit 16 is completed.

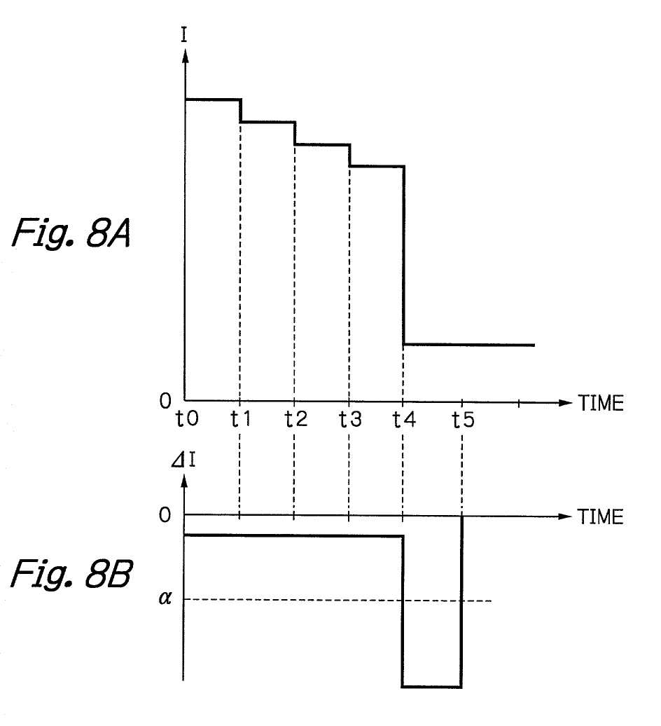

That is, the received light strength I is generally changed as shown in FIG. 8A. In this case, the difference ΔI is changed as shown in FIG. 8B. Therefore, when the edge of the optical shield plate 4(4′) is in conformity with the boundary between the display region 2a and the non-display region 2b of the liquid crystal panel body 2, the received light strength I is expected to be rapidly decreased, so that the differences ΔI is below the value α. In the above-described operation, at time t4 of FIGS. 8A and 8B, the location of the optical shield plate 4(4′) is fixed.

After the location of optical shield plate 4(4′) is fixed, the optical shield plate 4(4′) is adhered by adhesives or the screws 9 to the plastic frame 3. A double-coated tape may be used instead of adhesives.

In FIG. 6, if the optical shield plate 4(4′) is L-shaped, a stepping motor for moving the actuator 15 along the Y-direction is incorporated in the optical shield plate adjusting unit 14. In this case, the location of the optical shield plate 4(4′) along the Y-direction can be controlled in the same way as that along the X-direction.

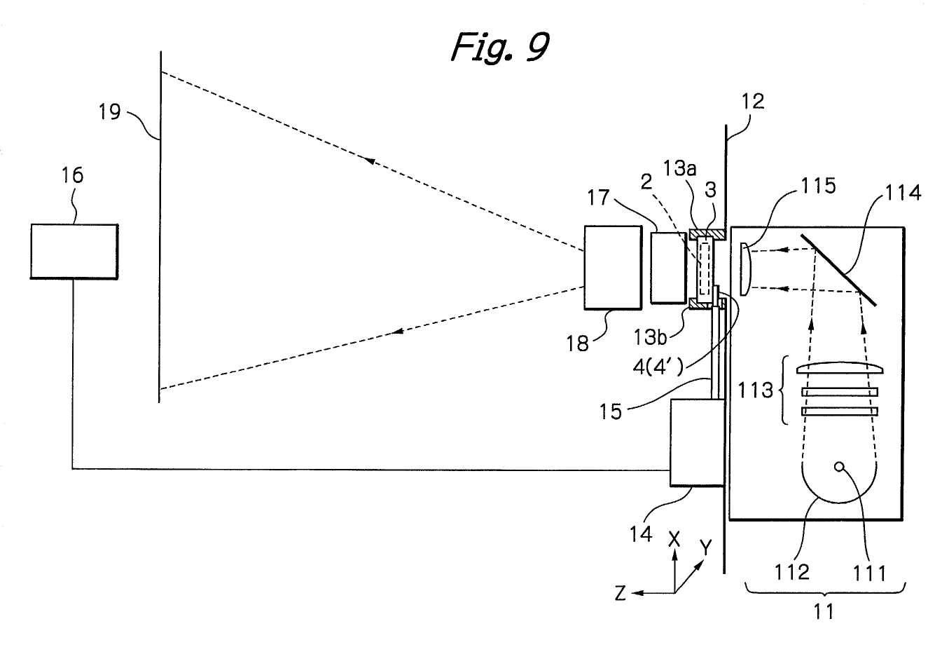

In FIG. 9, which illustrates a second apparatus for assembling the LCD apparatuses of FIGS. 1A, 1B, 1C; 2A, 2B, 2C; 3A, 3B, 3C; 4A, 4B, 4C; and 5A, 5B, 5C, a dichroic cross prism 17, a projection lens 18 and a semi-transparent screen 19 are provided between the plastic frame 3 and the optic shield plate location controlling unit 16 of FIG. 6. Since the assembling apparatus of FIG. 9 is similar to an actual projector, a realistic effect can be expected compared with the assembling apparatus of FIG. 6. Note that the operation of the assembling apparatus of FIG. 9 is the same as that of FIG. 6.

As explained hereinabove, according to the present invention, since an edge of an optical shield plate is completely in conformity with a boundary between the display region and non-display region of a liquid crystal panel body, generation of halations on a screen can be avoided.

1. A projection type liquid crystal display apparatus comprising:
a liquid crystal panel body including a display region and a non-display region surrounding said display region; and
at least one optical shield plate for covering said non-display region, an edge of said optical shield plate being completely in conformity with a boundary of said display region and said non-display region.

2. The projection type liquid crystal display apparatus as set forth in claim 1, wherein said optical shield plate is located on a side of said apparatus for receiving light.

3. The projection type liquid crystal display apparatus as set forth in claim 1, wherein said optical shield plate is I-shaped.

4. The projection type liquid crystal display apparatus as set forth in claim 1, wherein said optical shield plate is L-shaped.

5. The projection type liquid crystal display apparatus as set forth in claim 1, further comprising a plastic frame for mounting said liquid crystal panel body, said optical shield plate being adhered by adhesives to said plastic frame.

6. The projection type liquid crystal display apparatus as set forth in claim 1, further comprising a plastic frame for mounting said liquid crystal panel body, said optical shield plate being adhered by double-coated tape to said plastic frame.

7. The projection type liquid crystal display apparatus as set forth in claim 1, further comprising:
a plastic frame for mounting said liquid crystal panel body; and
a mounting plate, fixed on a side of said plastic frame, for mounting said optical shield plate.

8. The projection type liquid crystal display apparatus as set forth in claim 7, wherein said mounting plate is fixed by screws to said plastic frame.

9. The projection type liquid crystal display apparatus as set forth in claim 7, wherein adjusting holes are perforated in said mounting plate, said optical shield plate being adhered by adjusting screws through said adjusting holes to said mounting plate.

10. A projection type liquid crystal display apparatus comprising:
a liquid crystal panel body including a display region and a non-display region surrounding said display region;
a plastic frame for mounting said liquid crystal panel body; and
at least one optical shield plate, adhered to one side of said plastic frame, for covering said non-display region, an edge of said optical shield plate being completely in conformity with a boundary of said display region and said non-display region.

11. A method for assembling a projection type liquid crystal display apparatus, comprising the steps of:
irradiating a liquid crystal panel body including a display region and a non-display region surrounding said display region with light;
receiving light passed through said liquid crystal panel body while an optical shield plate in proximity to said liquid crystal panel body is moved along one direction; and
stopping motion of said optical shield plate when a change of strength of said received light is larger than a definite value, thus fixing said optical shield plate with respect to said liquid crystal panel body.

12. An apparatus for assembling a projection type liquid crystal display apparatus, comprising:
a light source;
amounting unit, provided on said light source, for mounting a liquid crystal panel body including a display region and a non-display region surrounding said display region;
an optical shield plate location adjusting unit for adjusting a location of an optical shield plate with respect to said mounting unit; and
an optical shield plate location controlling unit for receiving light passed through said liquid crystal panel body from said light source to control said optical shield plate location adjusting unit in accordance with light received by said optical shield plate location controlling unit.

13. The apparatus as set forth in claim 12, wherein said optical shield plate location controlling unit comprises:
an image pickup;
a processing unit, connected to said image pickup, for determining whether a change of strength of received light is larger than a predetermined value, so as to stop an operation of said optical shield plate location adjusting unit when the change of strength of received light is larger than the predetermined value.

14. The apparatus as set forth in claim 12, further comprising:
a dichroic cross prism for receiving a light passed through said liquid crystal panel body;
a projection lens for receiving light passed through said dichroic cross prism; and
a semi-transparent screen for receiving light passed through said projection lens,
said optical shield plate location controlling unit receiving light from said semi-transparent screen .
